(19) United States
(12) Patent Application Publication
(10) Pub. No.: US 2026/0106900 A1
(43) Pub. Date: Apr. 16, 2026

(54) MOBILE NETWORK USER IDENTIFICATION FUNCTION FOR IDENTIFYING, AUTHENTICATING, AND ASSOCIATING A USER TO A UE

(71) Applicant: Verizon Patent and Licensing Inc., Basking Ridge, NJ (US)

(72) Inventors: Utpal Khanvilkar, Basking Ridge, NJ (US); Vinod Kumar Choyi, Conshohocken, PA (US); Sudhakar Reddy Patil, Flower Mound, TX (US)

(21) Appl. No.: 18/912,022

(22) Filed: Oct. 10, 2024

(51) Int. Cl. H04L 9/40; H04W 8/18

(52) U.S. Cl. CPC H04L 63/20; H04L 63/08; H04W 8/18

(57) ABSTRACT

A network device implements a Network Function (NF). The NF receives a client credentials grant from a device credentialing service and receives a data session notification for a User Equipment device (UE) connected to a mobile network, where the notification includes the UE's International Mobile Subscriber Identity (IMSI). The NF requests, from the device credentialing service, validation of the NF based on the client credentials grant, and receives, from the device credentialing service, a token based on successful validation of the client credentials grant. The NF obtains, using the token, a user identity (ID) of a user associated with the UE, retrieves policies based on the user ID, and initiates one or more actions with respect to the UE's data session based on the retrieved policies.

### BACKGROUND

Mobile networks, such as, for example, Fourth Generation (4G) or Fifth Generation (5G) mobile networks, include numerous Network Functions (NFs) and/or Network Elements (NEs) that work cooperatively to operate the mobile network and provide wireless service to subscribing users and their user equipment devices (UEs). The NFs/NEs may perform, among many other functions, mobile network access management, session management, and policy control that enable the provision of wireless service to UEs.

### BRIEF DESCRIPTION OF THE DRAWINGS

FIG. 1 depicts an example network environment in which a mobile network includes a User Identification Function (UIF) that authenticates, identifies, and associates a mobile network user to a particular UE;

FIG. 2 is a diagram that depicts example components of a network device, as referred to herein;

FIG. 3 is a flow diagram of an example process for a UIF in a mobile network to establish a trust relationship with a Device Credentialing Service, enroll UEs in a mobile network NF-implemented user identification (ID) service described herein, and generate user ID-based UIF policies;

FIG. 4 is an example diagram associated with the process of FIG. 3;

FIG. 5A-5C are flow diagrams of a first example process for the UIF in the mobile network to obtain a User ID for a UE user, and to apply policies related to handling data session traffic of the UE based on the User ID;

FIGS. 6A and 6B are example diagrams associated with the process of FIG. 5A-5C;

FIG. 7A-7C are flow diagrams of a second example process for the UIF of the mobile network to obtain a User ID for a UE user, and to apply policies related to handling data session traffic of the UE based on the User ID of the user using the UE; and

FIG. 8A-8C are example diagrams associated with the process of FIG. 7A-7C.

### DETAILED DESCRIPTION

The following detailed description refers to the accompanying drawings. The same reference numbers in different drawings may identify the same or similar elements. The following detailed description does not limit the invention.

Mobile networks, such as 4G or 5G mobile networks, can authenticate a UE on the mobile network using an identity of the UE, such as, for example, the UE's International Mobile Subscriber Identifier (IMSI) or Subscription Permanent Identifier (SUPI). Access policies for applications, however, are typically based on a user profile that is tied to a user identity (e.g., a user ID), instead of a device or subscription identity. Having an authenticated device may be a necessary, but not sufficient, condition for a 4G or 5G network-based service that needs to provide access to an application. To provide access to an application, a user profile and authenticated user ID may also be required. Existing techniques to deal with this problem involve putting a client application on the UE itself to trigger user authentication. Using such a UE client application can be an unwieldy experience for the end-user and also requires that the client application be installed and managed on the UE.

As described herein, a new UIF NF may be introduced in the mobile network that identifies a user that is using each UE, without the need for a UE-based application or for other changes to the UE. The UIF NF, when implemented in a mobile network, operates to keep track of which user has logged into, or unlocked, a UE every time a UE becomes active (e.g., engages in a data session) on the mobile network. The UIF NF associates an authenticated UE with a particular user, authenticates the identity of the user when the UE is active, and may provide user-to-UE/IMSI/IMEI/SUPI mapping to other NFs or network services in the mobile network and/or to other applications inside or outside of the mobile network.

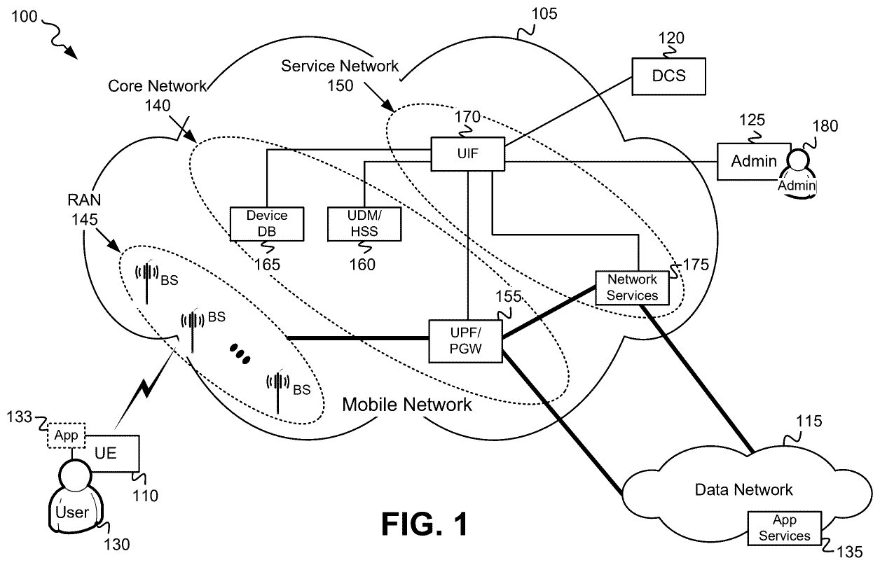

FIG. 1 depicts an example network environment 100 in which a mobile network includes a UIF that authenticates, identifies, and associates a mobile network user to a particular User Equipment device (UE). As shown, network environment 100 includes a mobile network 105, a UE 110, a data network 115, a Device Credentialing Service (DCS) 120, and an Administrator (Admin) device 125.

Mobile network 105 (also referred to herein as “wireless network 105” or “network 105”) may include any type of a Public Land Mobile Network (PLMN). In some implementations, mobile network 105 may include a 4G, 4.5G, and/or a 5G network. Mobile network 105 may include other types of Next Generation networks, such as a Sixth Generation (6G) network. Though mobile network 105 is shown in FIG. 1 as including 4G or 5G components, mobile network 105 may include, in some implementations, a hybrid Next Generation/4G network that includes certain components of both a Next Generation network (e.g., a 5G network) and a 4G network.

As shown, mobile network 105 may include sub-networks, such as a mobile Core Network 140, a Radio Access Network (RAN) 145, and a Service Network 150. Core network 140 includes devices or nodes that host and execute Network Functions (NFs) that operate the mobile network 105 including, among other NFs, mobile network access management, session management, and policy control NFs. In the example network environment 100 of FIG. 1, core network 140 is shown as including 4G/5G NFs, such as a User Plane Function (UPF)/Packet Gateway (PGW) 155, a Unified Data Management function (UDM)/Home Subscriber Server (HSS) 160, and a Device Database (DB) 165. Core network 140 may include other NFs not shown in FIG. 1, such as, for example, a Session Management Function (SMF), an Access and Mobility Management Function (AMF), a Mobility Management Entity (MME), a Charging Function (CHF), a Network Repository Function (NRF), and/or a Policy Control Function (PCF). Each NF in core network 140 may be implemented as a Virtual Network Function (VNF) or a Cloud-Native Network Function (CNF) (e.g., at a data center(s)) or as a Physical Network Function (PNF) within mobile network 105.

UPF/PGW 155 may act as a router and a gateway between mobile network 105 and data network 115, and forwards session data between data network 115 and RAN 145. Though only a single UPF/PGW 155 is shown in FIG. 1, mobile network 110 may include multiple UPFs/PGWs 155 at various locations in mobile network 105.

UDM/HSS 160 may manage data for user access authorization, user registration, and data network profiles. UDM/HSS 160 may include, or operate in conjunction with, a data storage element, such as a User Data Repository (UDR—not shown), which stores user data, such as customer/subscriber profile information, customer/subscriber authentication information, and/or encryption keys. The UDR associated with UDM/HSS 160 may store each UEs International Mobile Equipment Identity (IMEI) number in association with the UEs International Mobile Subscriber Identity (IMSI) or SUPI, such that a lookup may be performed to obtain a UE 110's IMEI based on the UE 110's IMSI/SUPI.

Device DB 165 includes a database that stores a data structure which associates each UE 110's IMEI number with a make, model, and/or vendor of the UE 110. A lookup may be performed into device DB 165, using a UE's IMEI, to retrieve a make, model, and/or vendor of the UE from an entry of DB 165 that corresponds to the IMEI.

RAN 145 may include various types of radio access equipment that enable RF communication with UE 110. The radio access equipment of RAN 145 may include, among other nodes/functions, multiple base stations (BSs). Each BS may include, for example, a NodeB node of a 4G network, or an evolved NodeB (eNodeB) of a Next Generation network. Each BS may be composed of sub-components (not shown) that may be distributed relative to one another, such as, for example, a Distributed Unit (DU), a Radio Unit (RU), a Control Unit-User Plane (CU-UP) function, and/or a Control Unit-Control Plane (CU-CP) function. Each BS may alternatively be composed of sub-components that are integrated with one another.

Each BS of RAN 145 may include a sub-component that hosts functions associated with the Radio Link Control (RLC) layer, the Medium Access Control (MAC) layer, and the physical layer (PHY) and interfaces with NFs in core network 140 to establish and manage connections with UE 110 and to facilitate communication between different BSs and/or cells of mobile network 105. Each BS of RAN 145 may further include sub-components that operate as radio function units that transmit and receive radio frequency (RF) signals to/from UE 110. Each radio function unit of each BS may include at least one antenna array, transceiver circuitry, and other hardware and software components for enabling the radio function unit to receive data via wireless RF signals from UE 110, and to transmit wireless RF signals to UE 110. RAN 145 may additionally include other nodes, functions, and/or components/sub-components not shown in FIG. 1.

Service network 150 may include one or more NFs or applications related to providing at least one network service to, or for, UE traffic. In one implementation, as shown in FIG. 1, service network 150 may include a User Identification Function (UIF) 170, and network services 175. UIF 170 may include a NF implemented by a network device (not shown) that performs various operations, described herein, related to obtaining a User ID of a user of a UE 110, and performing actions related to data session traffic of the UE 110 based on the obtained User ID, instead of based on the IMSI/SUPI or International Mobile Equipment Identifier (IMEI) of the UE 110. The User ID of each user may be associated with a user profile of the user.

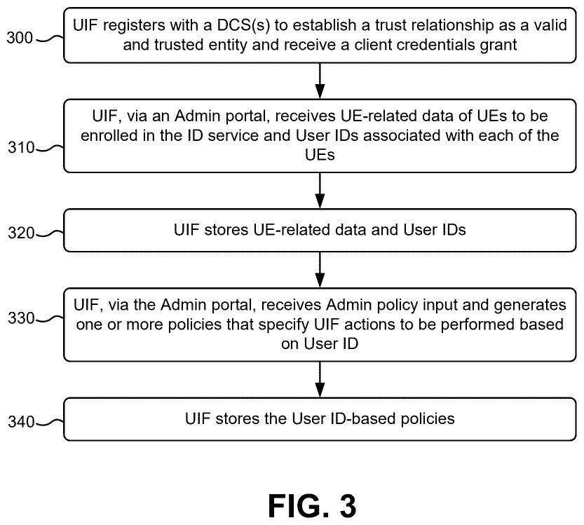

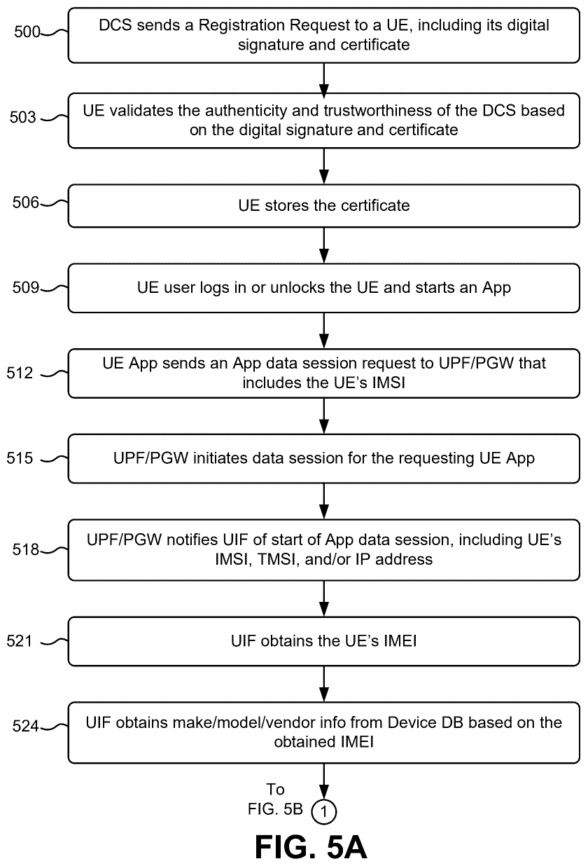

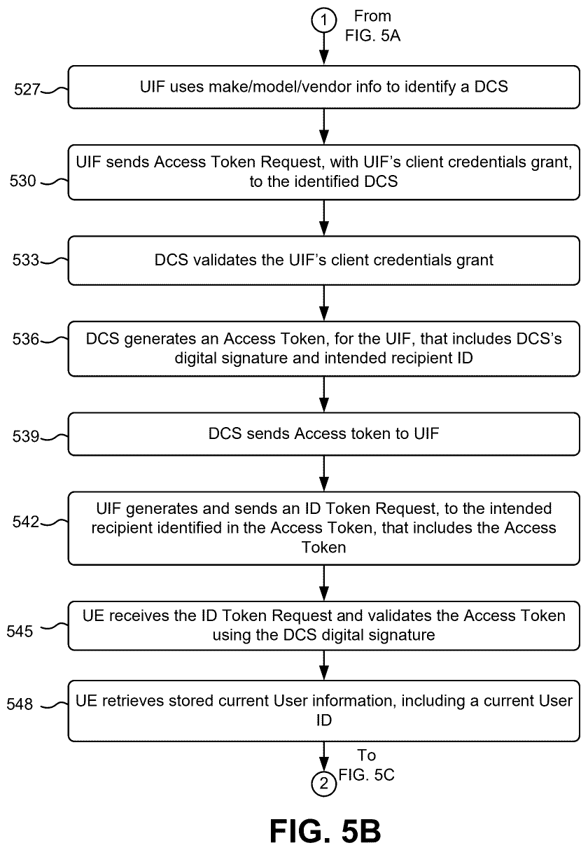

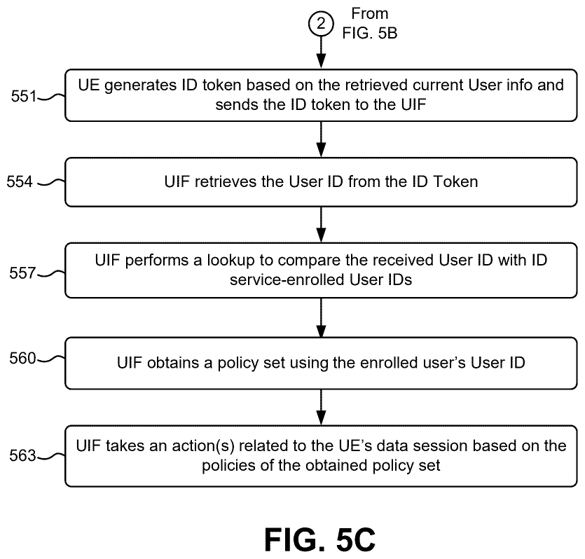

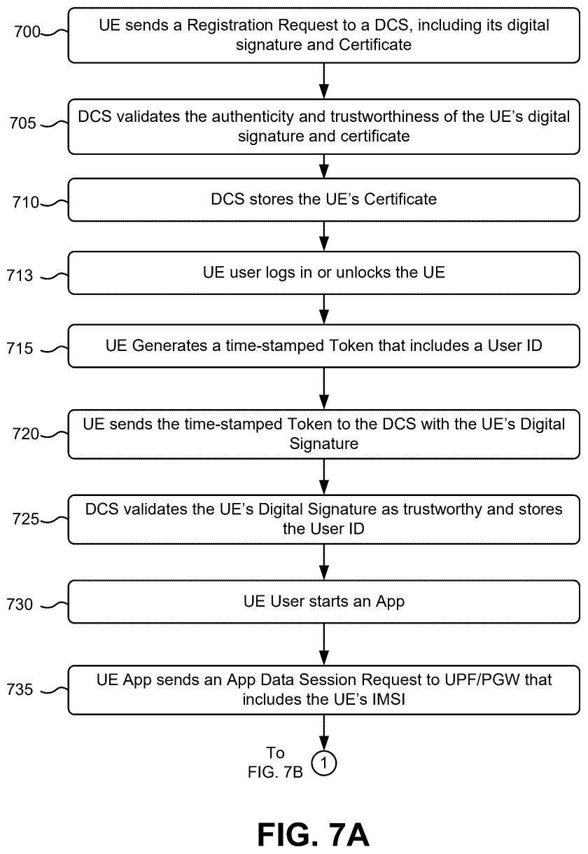

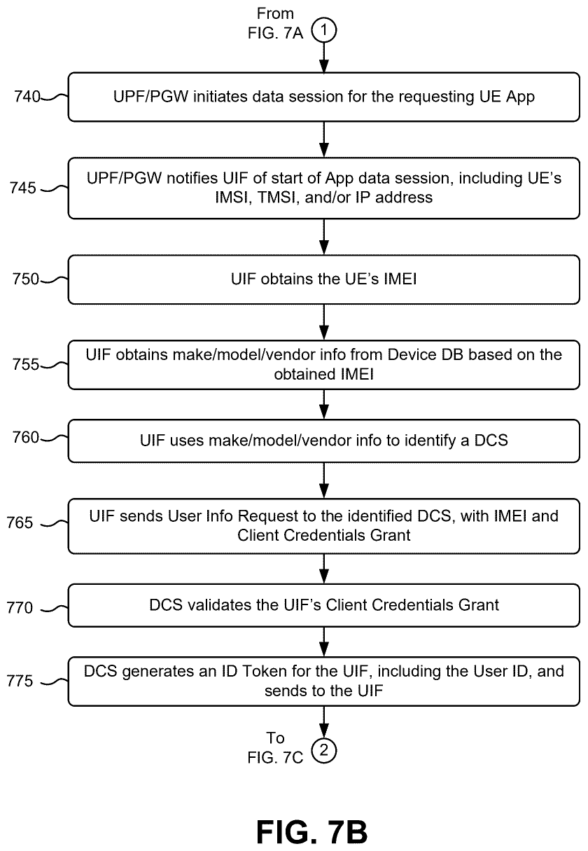

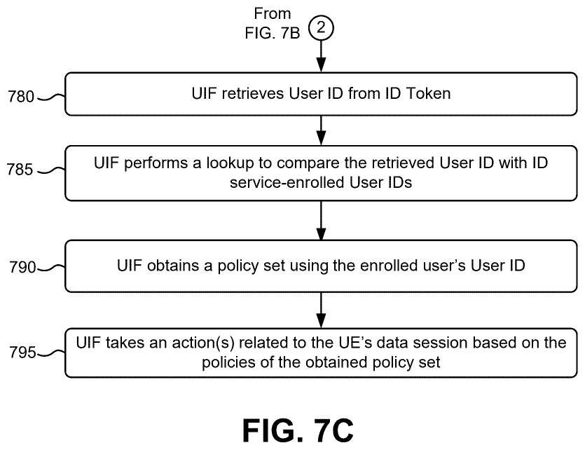

UIF 170 may perform the various operations described below with respect to the processes of FIG. 3, FIGS. 5A-5C, and FIGS. 7A-7C. Among other operations, UIF 170 may notify downstream network services 175 of the User ID associated with a UE 110's IMSI/SUPI, and may act as an Identity Provider (IDP) proxy to authenticate a user of a UE 110 for downstream network services 175 or applications.

Network services 175 include one or more network devices and/or other components that operate to perform at least one network service with respect to UE data session traffic. For example, data session traffic from a UE 110 may be routed by UPF/PGW 155 to network services 175 (and then possibly on to data network 115) such that one or more network devices may perform a network service, or multiple network services with respect to one or more data sessions of the data session traffic from the UE(s) 110. The network service(s) performed by network services 175 may include, for example, security services, local identity and authentication services, multi-access edge computing (MEC) deployed services, transport services, and/or specialized applications. The security services may include, for example, a firewall (e.g., Layer 3 (L3) firewall, Layer 7 (L7) firewall), Secure Gateways, Cloud Service brokers, Intrusion Detection/Prevention service, Malware Detection service, Secure Service Edge, and/or Secure Access Service Edge (SASE). The transport services may include, for example, private connections to private data centers, and/or private and public cloud connections. The specialized applications may include, for example, Push-to-Talk applications, user/device validation applications for banking or e-commerce, and/or shopping applications.

UE 110 may include any type of electronic device having a wireless communication capability. Though only a single UE 110 is shown, network environment 100 may include numerous UEs. UE 110 may include, for example, a laptop, palmtop, desktop, or tablet computer; a cellular phone (e.g., a “smart” phone); a Voice over Internet Protocol (VoIP) phone; a smart television (TV); an audio speaker (e.g., a “smart” speaker); a video gaming device; a music player (e.g., a digital audio player); a digital camera; a device in a vehicle; a wireless telematics device; an Augmented Reality/Virtual Reality (AR/VR) headset or glasses; or an Internet of Things (IoT) or Machine-to-Machine (M2M) device. A user (also referred to herein as a “subscriber”) may carry, use, administer, and/or operate UE 110. For example, as shown, a user 130 operates UE 110. UE 110 may have installed, and may execute based on input from user 130, at least one Application (App) 133. App 133, once executed, may engage in a data session(s) with App Services 135 (described below) residing in data network 115. The data session(s) may further involve execution one or more of network services 175, as described further below.

Data network 115 may include one or more interconnected networks, such as local area networks (LANs), wide area networks (WANs), metropolitan area networks (MANs), Public Switched Telephone Networks (PSTNs), Multi-Access Edge Computing networks (MECs), and/or the Internet. Data network 115 may, for example, connect with UPFs/PGWs 155 of mobile network 105. One or more App services 135 may reside in data network 115. Each App service 135 may be hosted by a network device (e.g., a server) that resides in data network 115 and interacts with App 133 at UE 110 to perform various services, functions, and/or operations.

DCS 120 may include one or more network devices that perform IDP authentication services, as described in further detail below. Though only one DCS 120 is shown in FIG. 1, DCS 120 may include multiple different DCSs that each provide independent IDP authentication services.

Admin device 125 includes at least one network device that provides an admin portal or interface for an administrator 180 of mobile network 105 to enroll certain UEs 110 in the mobile network-implemented ID service described herein. The administrator 180 may supply, via the admin portal provided by Admin device 125, IMSIs/SUPIs of UEs 110 to be enrolled in the ID service, User IDs of users that use each UE 110, and possibly an ID of a particular IDP (e.g., DCS 120) that can authenticate a user of a particular UE 110.

The configuration of network components of the example mobile network 105 of FIG. 1 is for illustrative purposes. Other configurations may be implemented. Therefore, mobile network 105 may include additional, fewer, and/or different components that may be configured in a different arrangement than that depicted in FIG. 1. For example, core network 140 may include other NFs not shown in FIG. 1. Additionally, though only a single instance of each of UPF/PGW 155, UDM/HSS 160, and device DB 165 is shown in FIG. 1, mobile network 110 may include multiple instances of each of these nodes/NFs. When implemented as Virtual NFs (VNFs) or Cloud Native Network Functions (CNFs), each of the NFs described above may be installed in, and executed by, a network device residing in mobile network 105, or in another network (e.g., in an edge or a far edge network, not shown). A single network device may host and execute one or more of the NFs, and mobile network 105 may include at least one network device, or may have multiple (e.g., numerous) network devices that each host and execute one or more of the NFs described above.

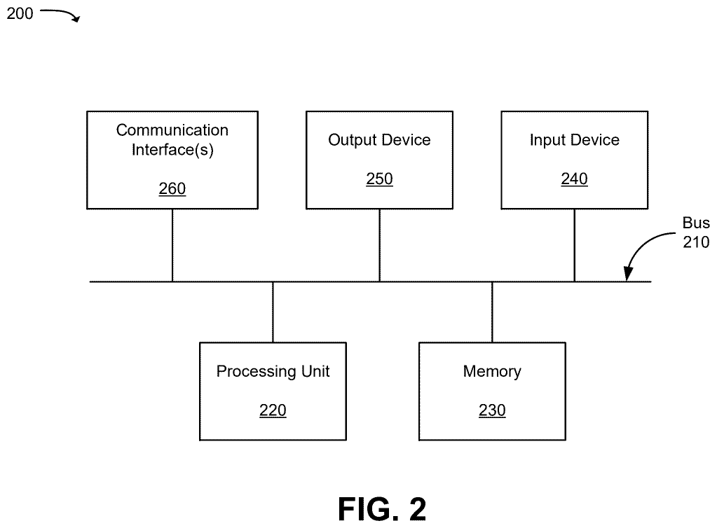

FIG. 2 is a diagram that depicts example components of a network device 200 (referred to herein as a “network device” or a “device”). UE 110, the BSs of RAN 145, DCS 120, and Admin device 125 may each include components that are the same as, or similar to, those of device 200 shown in FIG. 2. Furthermore, each of the NFs in mobile network 105 (e.g., UPF/PGW 155, UDM/HSS 160, device DB 165, other NFs not shown in FIG. 1) may be implemented by a device that includes components that are the same as, or similar to, those of network device 200. Some of the NFs of mobile network 105 may be implemented by a same device 200 within mobile network 105, while others of the NFs may be implemented by one or more separate devices 200 within mobile network 105.

Device 200 may include a bus 210, a processing unit 220, a memory 230, an input device 240, an output device 250, and a communication interface 260. Bus 210 may include a path that permits communication among the components of device 200. Processing unit 220 may include one or more processors or microprocessors which may interpret and execute instructions, or processing logic. Memory 230 may include one or more memory devices for storing data and instructions. Memory 230 may include a random access memory (RAM) or another type of dynamic storage device that may store information and instructions for execution by processing unit 220, a Read Only Memory (ROM) device or another type of static storage device that may store static information and instructions for use by processing unit 220, and/or a magnetic, optical, or flash memory recording and storage medium. The memory devices of memory 230 may each be referred to herein as a “tangible non-transitory computer-readable medium,” “non-transitory computer-readable medium,” or “non-transitory storage medium.” In some implementations, the processes/methods, or portions of the processes/methods, set forth herein can be implemented as instructions that are stored in memory 230 for execution by processing unit 220.

Input device 240 may include one or more mechanisms that permit an operator or administrator to input information into device 200, such as, for example, a keypad or a keyboard, a display with a touch sensitive panel, voice recognition and/or biometric mechanisms, etc. Output device 250 may include one or more mechanisms that output information to the operator, including a display, a speaker, etc. Input device 240 and output device 250 may, in some implementations, be implemented as a user interface (UI) that displays UI information and which receives user input via the UI. Communication interface 260 may include a transceiver(s) that enables device 200 to communicate with other devices and/or systems. For example, communication interface 260 may include one or more wired and/or wireless transceivers for communicating via mobile network 105 and/or data network 115. In the case of BSs of RAN 145, communication interface 260 may further include one or more antenna arrays for producing radio frequency (RF) cells or cell sectors that enable RF communication via mobile network 105.

The configuration of components of network device 200 illustrated in FIG. 2 is for illustrative purposes. Other configurations may be implemented. Therefore, network device 200 may include additional, fewer and/or different components, that may be arranged in a different configuration, than depicted in FIG. 2.

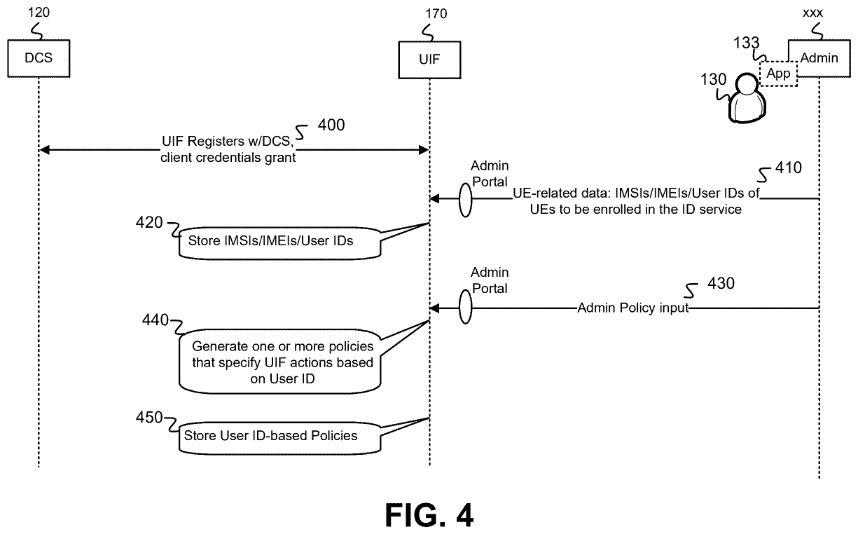

FIG. 3 is a flow diagram of an example process for UIF 170 to establish a trust relationship with a DCS(s) 120, enroll UEs 110 in the mobile network NF-implemented user ID service described herein, and generate user ID-based UIF policies. The example process of FIG. 3 may be implemented by UIF 170, in conjunction with Admin device 125. The process of FIG. 3 is described with additional reference to the example diagram of FIG. 4.

The example process includes UIF 170 registering with a DCS(s) 120 to establish a trust relationship as a valid and trusted entity and to receive a client credentials grant (block 300; 400, FIG. 4). UIF 170 may register with one or more DCSs 120, with each DCS 120, for example, being associated with a particular one of multiple device vendors. DCS 120, or an Identity Provider (IDP) server operating on behalf of DCS 120, may use the Open Authorization (OAuth) protocol and/or OpenID Connect protocol to authenticate and validate one or more of UIF 170's credentials received via a Registration Request. Various different credentials may be sent by UIF 170 to register with, and establish a trust relationship with, DCS 120. In one implementation, a symmetric key and a symmetric authentication process may be used to authenticate and validate the Registration Request from UIF 170. In another implementation, an asymmetric public and private key, and an asymmetric authentication process may be used to authenticate and validate the Registration Request from UIF 170. In a further implementation, a post-quantum resistant asymmetric public and private key, and a post-quantum asymmetric authentication process may be used to authenticate and validate the Registration Request from UIF 170. In an additional implementation, a hybrid scheme where a pre-quantum asymmetric public and private key, and a hybrid post-quantum asymmetric public and private key, may be used in conjunction with a hybrid asymmetric authentication process to authenticate and validate the Registration Request from UIF 170.

Upon successful authentication and validation of the Registration Request from UIF 170, using existing protocols such as, for example, OAuth and/or OpenID Connect, DCS 120, or the IDP server operating on behalf of DCS 120, issues a “client credentials grant,” which may include an Access Token, that may subsequently be used by UIF 170 to access DCS 120 via, for example, an Application Programming Interface (API). For example, the client credentials grant may be used by UIF 170 in the processes of FIG. 5A-5C or 7A-7C below to obtain access to a DCS 120. Each DCS 120 with which UIF 170 registers may send its own client credentials grant upon successful authentication of the respective Registration Request.

UIF 170, via an Admin portal, receives UE-related data of UEs 110 to be enrolled in the ID service and user IDs associated with each of the UEs 110 (block 310; 410, FIG. 4), and stores the UE-related data and the User IDs (block 320; 420, FIG. 4). The data provisioned via the Admin portal may include, for example, IMSIs and/or SUPIs of the UEs 110 to be enrolled in the ID service, and User IDs associated with each of the IMSIs/SUPIs. The provisioned data may further include, for example, an International Mobile Equipment Identity (IMEI) associated with each of the UEs 110. UIF 170 may store the IMSIs, SUPIs, and/or IMEI's, in association with the User IDs (e.g., each IMSI, SUPI, and/or IMEI stored in association with a respective User ID). An Administrator may use an Admin device 125 to access the Admin portal to UIF 170 to provide the IMSI numbers, SUPIs, and/or IMEIs of UEs 110 that are to be enrolled in the ID service implemented by UIF 170, and to further provide a User ID associated with each IMSI/SUPI/IMEI. In some circumstances, the Administrator may also provide an identification of the DCS 120 to be used for authentication for each IMSI/User ID. UIF 170 may store the IMSIs/SUPIs/IMEIs and User IDs in a local memory storage, or in an external memory storage (e.g., a database).

UIF 170, via the Admin portal, receives Admin policy input (430, FIG. 4) and generates one or more policies that specify UIF actions to be performed based on User ID (block 330; 440, FIG. 4), and stores the user ID-based policies (block 340; 450, FIG. 4). The Administrator may use Admin device 125 and the Admin portal to UIF 170 to provide the Admin policy input which UIF 170 uses to generate one or more policy rules that specify UIF actions to be performed in accordance with a User ID. In some implementations, the Admin policy input from the Administrator may describe particular network services that are available to a particular User ID(s). The one or more policy rules may include, for example, conditional statements (e.g., “if User ID_x, then UIF performs action_y”) that each map a particular User ID to one or more actions to be performed by UIF 170. UIF 170 may store the generated policy rules in the local memory storage at UIF 170, or in an external memory storage (e.g., a database). In some implementations, UIF 170 may store a per-User ID policy set in the memory storage. The User ID-based policy sets may be used in the processes of FIG. 5A-5C and FIG. 7A-7C below.

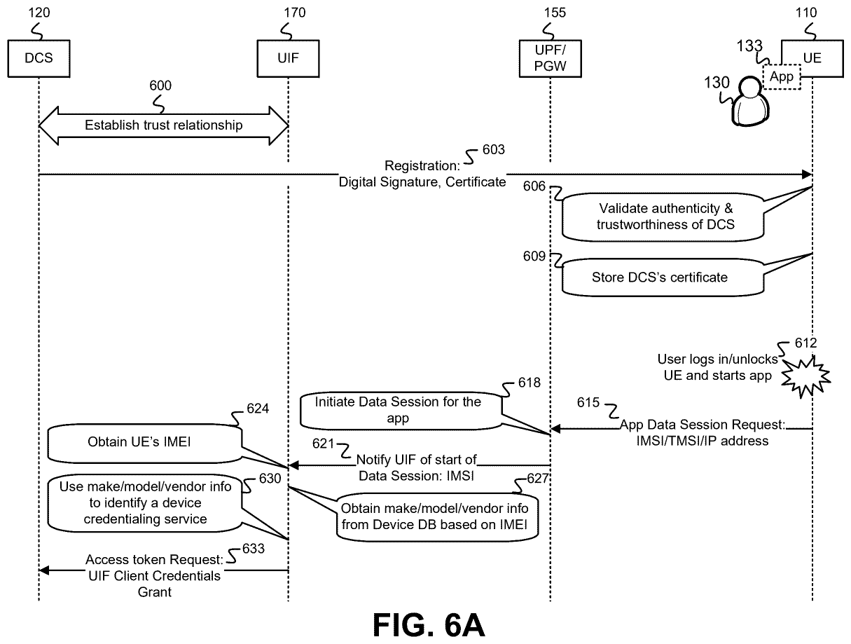

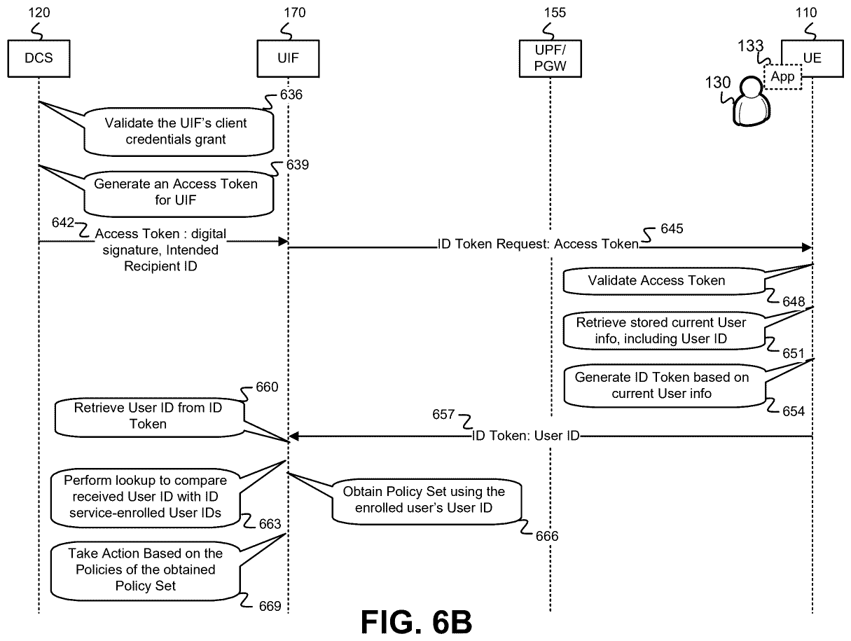

FIG. 5A-5C are flow diagrams of a first example process for UIF 170 to obtain a User ID for a user of a UE 110, and to apply policies related to handling data session traffic of the UE 110 based on the User ID, instead of the IMSI, SUPI, or IMEI associated with the UE 110. The example process of FIG. 5A-5C may be implemented by UIF 170, in conjunction with DCS 120, UE 110, and UPF/PGW 155. The process of FIG. 5A-5C is described with additional reference to the diagrams of FIGS. 6A and 6B. The process of FIG. 5A-5C may be performed subsequent to establishing a trust relationship between a DCS 120 and UIF 170, as described with respect to block 300 of FIG. 3, and illustrated at 600 in FIG. 6A.

The example process includes DCS 120 sending a Registration Request to a UE 110, including its digital signature and certificate (block 500). DCS 120 has previously obtained the digital certificate from a certificate issuer (e.g., in a Public-Key Infrastructure (PKI) architecture), where the digital certificate includes a public key of the DCS 120 (of a public key/private key pair), information about the identity of DCS 120 (or the owner/operator of DCS 120), and the digital signature of the certificate issuer. In certain cases, the PKI may belong to a domain associated with the DCS 120. Prior to sending the Registration Request, DCS 120 uses its private key, of the public key/private key pair, to sign the Request with a digital signature. UE 110 validates the authenticity and trustworthiness of the DCS 120 based on the DCS 120's digital signature and certificate (block 503), and stores the DCS 120's certificate (block 506). Upon receipt of the Registration Request, UE 110 extracts the DCS 120's public key from the certificate and verifies the authenticity of the digital signature (and thereby the trustworthiness of the DCS 120) used to sign the Registration Request using the DCS 120's public key. The example of FIG. 6A depicts DCS 120 sending a Registration 603, that includes a digital signature and certificate, to UE 110. As further shown in FIG. 6A, upon receipt of the Registration 603, UE 110 validates 606 the authenticity and trustworthiness of the DCS 120 based on the digital signature and certificate, and stores 609 the DCS 120's certificate.

The UE user 130 logs in or unlocks the UE 110 and starts an application (e.g., App 133) (block 509), and the App 133 sends an app data session request to UPF/PGW 155 that includes the UE 110's IMSI (block 512). The app data session request may additionally, or alternatively, include the UE 110's SUPI, Temporary Mobile Subscriber Identity (TMSI), and/or Internet Protocol (IP) address. The user 130 using UE 110 either logs into UE 110 (e.g., with a PIN code or password), or unlocks the UE 110 using biometric mechanisms (e.g., fingerprint scanner, facial image analysis), and then executes App 133 that initiates a data session via mobile network 105. Any type of data session that may, or may not, engage network services 175 in service network 150 of mobile network 105 may be initiated based on the particular App 133. The example of FIG. 6A illustrates user 130 at UE 110 logging in or unlocking 612 UE 110 and starting App 133, and App 133 sending an app data session request 615, that includes the UE 110's IMSI, SUPI, TMSI, and/or IP address, to UPF/PGW 155.

UPF/PGW 155 initiates a data session for the requesting app 133 (block 515), and notifies UIF 170 of the start of the app data session, including the UE 110's IMSI, SUPI, TMSI, and/or IP address (block 518). Upon receipt of the app data session request from App 133, UPF/PGW 155 begins forwarding the data units (e.g., packets) of the session to App services 135 in data network 115, or to network services 175 in service network 150 and on to App services 135 in data network 115. The example of FIG. 6A depicts UPF/PGW 155, upon receipt of app Data Session Request 615 from App 133 at UE 110, initiating 618 a data session for the App 133, and sending a notification 621 to UIF 170 of the start of a data session, where the notification 621 includes the IMSI, SUPI, TMSI, and/or IP address of UE 110.

UIF 170 obtains the UE 110's IMEI (block 521), and obtains make, model, and/or vendor information from Device DB 165 based on the obtained IMEI (block 524). In one implementation, UIF 170 may obtain the UE 110's IMEI from memory (e.g., previously provisioned via the Admin portal in block 310 of FIG. 3). In another implementation, UIF 170 may obtain the UE 110's IMEI from UDM/HSS 160 based on the UE 110's IMSI, SUPI, TMSI and/or IP address. UIF 170 further uses the make, model, and/or vendor information to identify a particular DCS 120 (block 527), and sends an Access Token Request, with UIF 170's client credentials grant, to the identified DCS 120 (block 530). The example of FIG. 6A shows UIF 170 obtaining 624 the UE 110's IMEI, and obtaining 627 make, model, and/or vendor information from device DB 165 (not shown in FIG. 6A) based on the IMEI. FIG. 6A further shows UIF 170 using the obtained make, model, and/or vendor information to identify a device credentialing service (e.g., DCS 120) to which UIF 170 may submit its client credentials grant (e.g., received in block 300 of FIG. 3), and sending an Access Token Request 633, that includes UIF 170's client credentials grant to the identified DCS 120.

DCS 120, upon receipt of the Access Token Request, validates the UIF's client credentials grant (block 533), generates an Access Token, for the requesting UIF 170, that includes the DCS 120's digital signature and an intended recipient ID (block 536), and sends the Access Token to the UIF 170 (block 539). For example, DCS 120 validates the client credentials grant by verifying that the client credentials grant sent by UIF 170 in the Access Token Request is the same as that previously sent to UIF 170 in block 300 of FIG. 3. FIG. 6B illustrates DCS 120 validating 636 the UIF 170's client credentials grant, generating 639 an access token for UIF 170, and sending the Access Token, in a message 642 that includes DCS 120's digital signature and an intended recipient ID, to UIF 170.

UIF 170 generates and sends an ID Token Request, to the intended recipient in the Access Token, that includes the Access Token (block 542). Upon receipt of the message that includes the Access Token from DCS 120, UIF 170 extracts the access token and the intended recipient ID. UIF 170 then generates the ID Token Request, and includes the Access Token, and sends the ID Token Request to the UE 110 that corresponds to the intended recipient ID received from DCS 120. FIG. 6B depicts UIF 170 sending an ID Token Request 645, that includes the Access Token, to UE 110.

UE 110, as the intended recipient, receives the ID Token Request and validates the Access Token using the DCS digital signature (block 545). UE 110 extracts DCS 120's digital signature from the Access Token, and retrieves a previously stored certificate for the DCS 120 (e.g., received in block 503, and stored in block 506, of FIG. 5A). UE 110 extracts DCS 120's public key from the certificate and uses the public key to validate the digital signature of DCS 120 and to thereby validate the Access Token itself. The example of FIG. 6B illustrates UE 110 receiving the ID Token Request 645, and validating 648 the Access Token.

UE 110 retrieves stored current User info, including the current User ID (block 548), and generates an ID Token based on the retrieved current user info and sends the ID Token to the UIF 170 (block 551). The ID Token includes the current User ID of the user 130 using UE 110. The user information may include other information associated with the user 130 other than, or in addition to, the current User ID. FIG. 6B depicts UE 110 retrieving 651 stored current User information for user 130 stored in memory at UE 110, and generating 654 an ID Token based on the current User information. FIG. 6B further depicts UE 110 sending the ID Token 657, and the User ID, to UIF 170.

UIF 170, upon receipt of the ID Token, retrieves the User ID from the ID token (block 554), and performs a lookup to compare the received User ID with ID service-enrolled User IDs (block 557). UIF 170 stores user IDs of users previously enrolled in the mobile network implemented ID service (e.g., enrolled in block 310 of FIG. 3), and UIF 170 may compare, via a lookup, the User ID retrieved from the ID Token with the stored User IDs of enrolled users. If, during the lookup, UIF 170 determines a match between the User ID retrieved from the ID token, and one of the stored User IDs of users previously enrolled in the mobile network-implemented ID services, then UIF 170 proceeds with block 560 below. If UIF 170 determines that there is no match, then the process may end at block 557, and blocks 560 and 563 may not be executed. In certain circumstances, the UIF 170 may not perform a check of the locally stored User IDs to the one that is included in the ID Token and may initiate appropriate services without performing the check. The example of FIG. 6B shows UIF 170 receiving the ID Token 657, including the User ID of user 130 at UE 110, and retrieving 660 the User ID from the ID Token 657. FIG. 6B further shows performing 663 a lookup to compare the received User ID with ID service-enrolled User IDs previously stored by UIF 170.

UIF 170 obtains a policy set using the enrolled user's User ID (block 560) and takes an action(s) related to the UE 110's data session based on the policies of the obtained policy set (block 563). For example, UIF 170 performs a lookup, based on the user's User ID, to retrieve a set of policies, that were generated in block 330, whose User ID matches the User ID retrieved from the ID Token in block 554. The one or more policies may, for example, specify that UIF 170 notify network services 175 of the User ID associated with the UE 110's IMSI, SUPI, TMSI, or IP address such that the network services can perform one or more User ID-based services with respect to the UE 110's data session (e.g., security services, MEC deployed services, transport services, specialized applications). The one or more policies may further specify that UIF 170 act as an IDP proxy and authenticate the user 133 of UE 110 for downstream applications (e.g., network services 175 in service network 150, App services 135 in data network 115). The example of FIG. 6B depicts UIF 170 obtaining 666 a policy set using the enrolled user 130's User ID, and taking 669 action based on the policy(ies) of the obtained policy set.

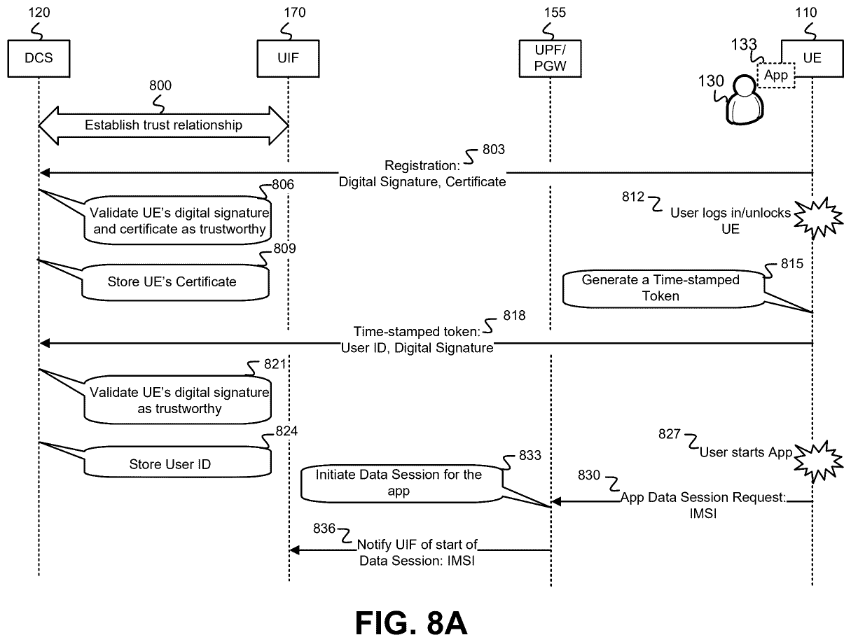

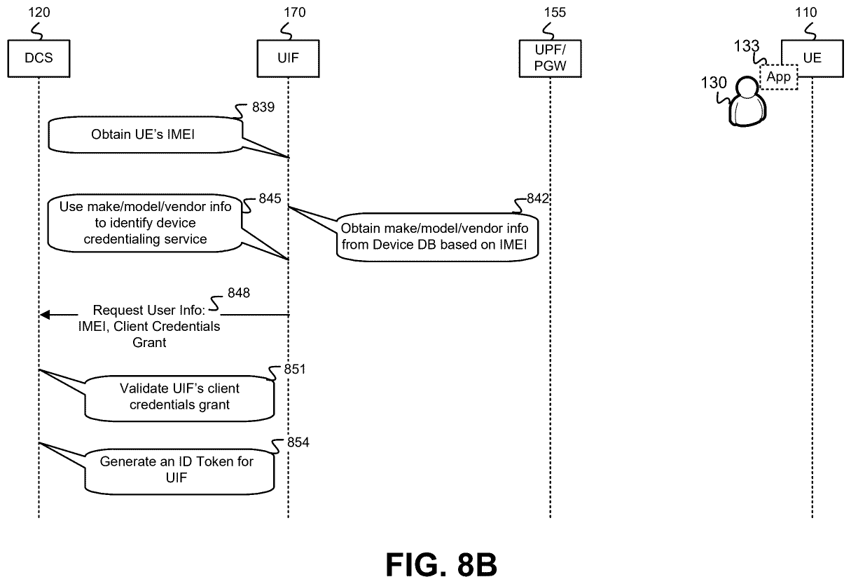

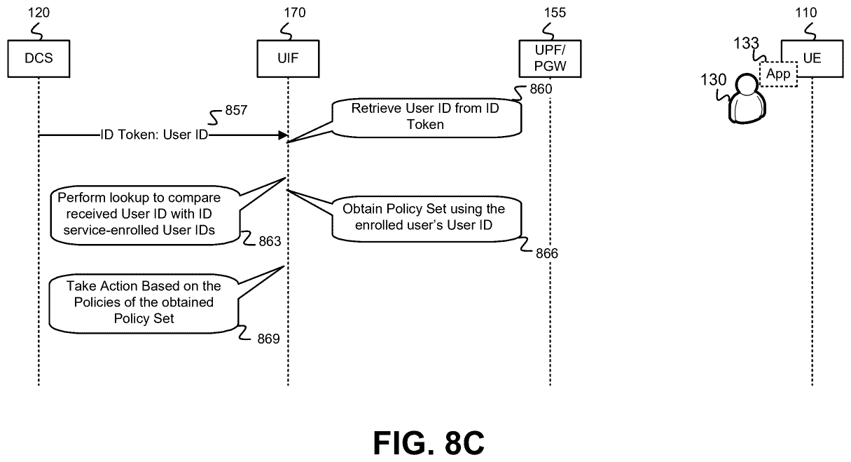

FIG. 7A-7C are flow diagrams of a second example process for UIF 170 to obtain a User ID for a user of a UE 110, and to apply policies related to handling data session traffic of the UE 110 based on the User ID of the user 133 using UE 110, instead of the IMSI or IMEI associated with the UE 110. The example process of FIG. 7A-7C may be implemented by UIF 170, in conjunction with DCS 120, UE 110, and UPF/PGW 155. The process of FIG. 7A-7C is described with additional reference to the diagrams of FIGS. 8A-8C . The process of FIG. 7A-7C may be performed subsequent to establishing a trust relationship between a DCS 120 and UIF 170, as described with respect to block 300 of FIG. 3, and illustrated at 800 in FIG. 8A.

The example process includes a UE 110 sending a Registration Request to a DCS 120, including its digital signature and certificate (block 700). UE 110 has previously obtained the digital certificate from a certificate issuer (e.g., in a Public-Key Infrastructure (PKI) architecture), where the digital certificate includes a public key of the UE 110 (of a public key/private key pair), information about the identity of UE 110, and the digital signature of the certificate issuer. In certain cases, the PKI may belong to a domain associated with the DCS 120. Prior to sending the Registration Request, UE 110 uses its private key, of the public key/private key pair, to sign the Request with a digital signature.

DCS 120 validates the authenticity and trustworthiness of the UE's digital signature and certificate (block 705), and stores the UE 110's certificate (block 710). Upon receipt of the Registration Request, DCS 120 extracts the UE 110's public key from the certificate and verifies the authenticity of the digital signature (and thereby the trustworthiness of the UE 110) used to sign the Registration Request using the UE 110's public key. The example of FIG. 8A depicts UE 110 sending a Registration 803, that includes a digital signature and certificate, to DCS 120. As further shown in FIG. 8A, upon receipt of the Registration 803, DCS 120 validates 806 the authenticity and trustworthiness of the UE 110 based on the digital signature and certificate, and stores 809 the UE 110's certificate.

The user 130 of UE 110 logs into, or unlocks UE 110 (block 713), and UE 110 generates a time-stamped Token that includes the User ID of user 130 (block 715). UE 110 then sends the time-stamped Token to the DCS 120 with the UE 110's digital signature (block 720). The user 130 using UE 110 either logs into UE 110 (e.g., with a PIN code or password), or unlocks the UE 110 using biometric mechanisms (e.g., fingerprint scanner, facial image analysis). UE 110 creates, and time stamps a token, and inserts the User ID of user 130 into the token. UE 110 then, using its private key of a public/private key pair, signs the token with a digital signature. FIG. 8A shows user 130 logging into 812, or unlocking, UE 110, and UE 110 generating 815 a time-stamped Token 818 and sending the Token 818, that includes a User ID of user 130 and UE 110's digital signature, to DCS 120.

DCS 120 validates the UE 110's digital signature as trustworthy and stores the User ID (block 725). Upon receipt of the time-stamped token from UE 110, DCS 120 extracts the UE 110's digital signature and uses the public key from the UE 110's certificate (received in blocks 700 and 705) to verify the authenticity of the digital signature (and thereby the trustworthiness of the ID Token from the UE 110) used to sign the ID Token using the UE 110's public key. FIG. 8A illustrates DCS 120, upon receipt of Token 818, validating 821 the UE 110's digital signature as trustworthy, and storing 824 user 130's User ID.

The user 130 of the UE 110 starts an App 133 (block 730), and the App 133 sends an App Data Session Request to UPF/PGW 155 that includes the UE 110's IMSI, SUPI, TMSI, and/or IP address (block 735). If, for example, UE 110 is a touch screen device, the user 130 may touch an icon of the App 133 to start the App 133 and the data session involving the App 133 may subsequently be initiated. Any type of data session that may, or may not, engage network services 175 in service network 150 of mobile network 105 may be initiated based on the particular type of App 133. UPF/PGW 155 initiates a data session for the requesting App 133 (block 740) (FIG. 7B), and notifies UIF 170 of the start of the App data session, including the UE 110's IMSI, SUPI, TMSI, and/or IP address (block 745). Upon receipt of the App data session request from App 133, UPF/PGW 155 begins forwarding the data units (e.g., packets) of the session to App services 135 in data network 115, or to network services 175 in service network 150 and on to App services 135 in data network 115. The example of FIG. 8A illustrates user 130 at UE 110 starting 827 App 133, and App 133 sending an App data session request 830, that includes the UE 110's IMSI, SUPI, TMSI, and/or IP address, to UPF/PGW 155. FIG. 8A further illustrates UPF/PGW 155, upon receipt of App Data Session Request 830 from App 133 at UE 110, initiating 833 a data session for the App 133, and sending a notification 836 to UIF 170 of the start of a data session, where the notification 836 includes the IMSI, TMSI, and/or IP address of UE 110.

UIF 170 obtains the UE 110's IMEI (block 750), and obtains make, model, and/or vendor information from Device DB 165 based on the IMEI (block 755). In one implementation, UIF 170 may obtain the UE 110's IMEI from memory (e.g., previously received via the Admin portal in block 310 of FIG. 3). In another implementation, UIF 170 may obtain the UE 110's IMEI from UDM/HSS 160 based on the UE 110's IMSI, SUPI, TMSI and/or IP address. UIF 170 may additionally obtain other data provisioned by the Admin 180, via the Admin portal, in block 310 of FIG. 3. UIF 170 further uses the make, model, and/or vendor information to identify a particular DCS 120 (block 760), and sends a User Info Request to the identified DCS 120, with the UE 110's IMEI and a Client Credentials Grant (block 765). The client credentials grant may include that granted to the UIF 170 in block 300 of FIG. 3. The example of FIG. 8B shows UIF 170 obtaining 839 the UE's IMEI, and obtaining 842 make, model, and/or vendor information from device DB 165 (not shown in FIG. 8B). FIG. 8B further shows UIF 170 using 845 the obtained make, model, and/or vendor information to identify a device credentialing service (e.g., DCS 120) to which UIF 170 may request user information regarding user 130 of UE 110. FIG. 8B additionally shows UIF 170 sending a Request User Info message 848, that includes UE 110's IMEI and the client credentials grant previously granted to UIF 170 in block 300 of FIG. 3, to the DCS 120 identified in block 760.

DCS 120, upon receipt of the User Info Request, validates the UIF 170's Client Credentials Grant (block 770), and generates an ID Token for the UIF 170, including the User ID, and sends the ID Token to the UIF 170 (block 775). For example, DCS 120 may validate the client credentials grant by verifying that the client credentials grant is the same as that previously sent by DCS 120 to UIF 170 in block 300 of FIG. 3. FIG. 8B depicts UIF 170 validating 851 the UIF's client credentials grant, and generating 854 an ID token for the UIF 170. FIG. 8C further depicts DCS 120 returning the ID Token 857 to the requesting UIF 170.

UIF 170 retrieves the User ID from the received ID Token (block 780) and performs a lookup to compare the retrieved User ID with ID service-enrolled User IDs (block 785). UIF 170 stores user IDs of users previously enrolled in the mobile network implemented ID service (e.g., enrolled in block 310 of FIG. 3), and UIF 170 may compare, via a lookup, the User ID retrieved from the ID Token with the stored User IDs of enrolled users. If, during the lookup, UIF 170 determines a match between the User ID retrieved from the ID token, and one of the stored User IDs of users previously enrolled in the mobile network-implemented ID services, then UIF 170 proceeds with block 790 below. If UIF 170 determines that there is no match, then the process may end at block 785, and blocks 790 and 795 may not be executed. The example of FIG. 8C shows UIF 170 receiving the ID Token 857, including the User ID of user 130 at UE 110, and retrieving 860 the User ID from the ID Token 857. FIG. 8C further shows UIF 170 performing 863 a lookup to compare the received User ID with ID service-enrolled User IDs previously stored by UIF 170.

UIF 170 obtains a policy set using the enrolled user's User ID (block 790), and takes an action(s) related to the UE 110's data session based on the policies of the obtained policy set (block 795). UIF 170 performs a lookup, based on the user's User ID, to retrieve a set of policies, that were generated in block 330, whose User ID matches the User ID retrieved from the ID Token in block 780. The one or more policies may, for example, specify that UIF 170 notify network services 175 of the User ID associated with the UE 110's IMSI, SUPI, TMSI, or IP address such that the network services can perform one or more User ID-based services with respect to the UE 110's data session (e.g., security services, MEC deployed services, transport services, specialized applications). The one or more policies may further specify that UIF 170 act as an IDP proxy and authenticate the user 133 of UE 110 for downstream applications (e.g., network services 175 in service network 150, App services 135 in data network 115). The example of FIG. 8C depicts UIF 170 obtaining 866 a policy set using the enrolled user 130's User ID, and taking 869 action based on the policy(ies) of the obtained policy set.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with respect to FIGS. 3, 5A-5C, and 7A-7C, and sequences of operations, messages, and/or data flows with respect to FIGS. 4, 6A-6B , and 8A-8C, the order of the blocks and/or the operations, messages, and/or data flows may be varied in other implementations. Moreover, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processing unit 220) of a device. A non-transitory storage medium includes one or more of the storage mediums described in relation to memory 230. The non-transitory computer-readable storage medium may be implemented in a centralized, distributed, or logical division that may include a single physical memory device or multiple physical memory devices spread across one or multiple network devices.

To the extent the aforementioned embodiments collect, store or employ personal information of individuals, such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage and use of personal information can be in an appropriately secure manner reflective of the type of information, for example, through various encryption and anonymization techniques for particularly sensitive information.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

All structural and functional equivalents to the elements of the various aspects set forth in this disclosure that are known or later come to be known to those of ordinary skill in the art are expressly incorporated herein by reference and are intended to be encompassed by the claims.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed IS:

1. A method, comprising:
receiving, by a Network Function (NF), a client credentials grant from a device credentialing service;
receiving, by the NF, a data session notification for a User Equipment device (UE) connected to a mobile network, wherein the notification includes the UE's International Mobile Subscriber Identity (IMSI);
requesting, by the NF from the device credentialing service, validation of the NF based on the client credentials grant;
receiving, by the NF from the device credentialing service, a token based on successful validation of the client credentials grant;
obtaining, by the NF using the token, a user identity (ID) of a user associated with the UE;
retrieving, by the NF, policies based on the user ID; and
initiating one or more actions, by the NF, with respect to the UE's data session based on the retrieved policies.

2. The method of claim 1, wherein the client credentials grant comprises an access token granted to the NF by the device credentialing service.

3. The method of claim 1, wherein initiating the one or more actions further comprises:
notifying, by the NF, network services in the mobile network of the obtained user ID such that the network services can perform one or more user ID-based services with respect to the UE's data session.

4. The method of claim 1, wherein initiating the one or more actions further comprises:
acting, by the NF, as an Identity Provider (IDP) proxy and authenticating the user associated with the UE for downstream applications.

5. The method of claim 1, wherein the NF receives the client credentials grant during execution of at least one of an Open Authorization (OAuth) protocol or an Open ID Connect protocol.

6. The method of claim 1, further comprising:
sending an ID token Request to the UE that includes the token received from the device credentialing service; and
wherein obtaining the user ID further comprises:
receiving from the UE, based on successful validation of the token, an ID token that includes the user ID, and
extracting the user ID from the ID token.

7. The method of claim 1, wherein the token received from the device credentialing service comprises an ID token that includes the user ID of the user, and
wherein obtaining the user ID of the user comprises:
extracting, by the NF from the ID token, the user ID of the user.

8. A network device, comprising:
at least one communication interface configured to communicate via a mobile network; and
at least one processor configured to execute a Network Function (NF) to:
receive, via the at least one communication interface, a client credentials grant from a device credentialing service,
receive, via the at least one communication interface, a data session notification for a User Equipment device (UE) connected to the mobile network, wherein the notification includes the UE's International Mobile Subscriber Identity (IMSI),
request, from the device credentialing service, via the at least one communication interface, validation of the NF based on the client credentials grant,
receive, from the device credentialing service, via the at least one communication interface, a token based on successful validation of the client credentials grant,
obtain, using the token, a user identity (ID) of a user associated with the UE;
retrieve policies based on the user ID, and
initiate one or more actions, via the at least one communication interface, with respect to the UE's data session based on the retrieved policies.

9. The network device of claim 8, wherein the client credentials grant comprises an access token granted to the NF by the device credentialing service.

10. The network device of claim 8, wherein, when initiating the one or more actions, the at least one processor is further configured to execute the NF to:
notify, via the at least one communication interface, network services in the mobile network of the obtained user ID such that the network services can perform one or more user ID-based services with respect to the UE's data session.

11. The network device of claim 8, wherein, when initiating the one or more actions, the at least one processor is further configured to execute the NF to:
act as an Identity Provider (IDP) proxy and authenticate the user associated with the UE for downstream applications.

12. The network device of claim 8, wherein the at least one processor is further configured to execute the NF to:
send, via the at least one communication interface, an ID token Request to the UE that includes the token received from the device credentialing service; and
wherein, when obtaining the user ID, the at least one processor is further configured to execute the NF to:
receive from the UE, based on successful validation of the token, an ID token that includes the user ID, and
extract the user ID from the ID token.

13. The network device of claim 8, wherein the token received from the device credentialing service comprises an ID token that includes the user ID of the user, and
wherein, when obtaining the user ID of the user, the at least one processor is further configured to execute the NF to:
extract, from the ID token, the user ID of the user.

14. A non-transitory storage medium storing instructions executable by a network device, wherein execution of the instructions causes the network device to implement a Network Function (NF) to:
receive a client credentials grant from a device credentialing service;
receive a data session notification for a User Equipment device (UE) connected to a mobile network, wherein the notification includes the UE's International Mobile Subscriber Identity (IMSI);
request, from the device credentialing service, validation of the NF based on the client credentials grant;
receive, from the device credentialing service, a token based on successful validation of the client credentials grant;
obtain, using the token, a user identity (ID) of a user associated with the UE;
retrieve policies based on the user ID; and
initiate one or more actions with respect to the UE's data session based on the retrieved policies.

15. The non-transitory storage medium of claim 14, wherein the client credentials grant comprises an access token granted to the NF by the device credentialing service.

16. The non-transitory storage medium of claim 14, wherein, when initiating the one or more actions, execution of the instructions further causes the network device to implement the NF to:
notify network services in the mobile network of the obtained user ID such that the network services can perform one or more user ID-based services with respect to the UE's data session.

17. The non-transitory storage medium of claim 14, wherein, when initiating the one or more selected actions, execution of the instructions further causes the network device to implement the NF to:
act as an Identity Provider (IDP) proxy and authenticate the user associated with the UE for downstream applications.

18. The non-transitory storage medium of claim 14, wherein the NF receives the client credentials grant during execution of at least one of an Open Authorization (OAuth) protocol or an Open ID Connect protocol.

19. The non-transitory storage medium of claim 14, wherein execution of the instructions further causes the network device to implement the NF to:
send an ID token Request to the UE that includes the token received from the device credentialing service; and
wherein, when obtaining the user ID, execution of the instructions further causes the network device to implement the NF to:
receive from the UE, based on successful validation of the token, an ID token that includes the user ID, and
extract the user ID from the ID token.

20. The non-transitory storage medium of claim 14, wherein the token received from the device credentialing service comprises an ID token that includes the user ID of the user, and
wherein, when obtaining the user ID of the user, execution of the instructions further causes the network device to implement the NF to:
extract, from the ID token, the user ID of the user.
